(19) United States
(12) Patent Application Publication
(10) Pub. No.: US 2026/0063510 A1
(43) Pub. Date: Mar. 5, 2026

(54) PUMP SHAFT SEAL LIFE PREDICTION SYSTEM AND METHOD

(71) Applicant: DELTA ELECTRONICS, INC., Taoyuan City (TW)

(72) Inventors: Che-Hsuan YU, Taoyuan City (TW); Jin-Long LIN, Taoyuan City (TW); Chi-Tsan CHIU, Taoyuan City (TW); Hsiang-Yu YEH, Taoyuan City (TW); Po-Wen HUANG, Taoyuan City (TW)

(21) Appl. No.: 19/026,166

(22) Filed: Jan. 16, 2025

(30) Foreign Application Priority Data
Sep. 4, 2024 (CN) 202411232408.1

(51) Int. Cl. G01M 13/005; F04B 51/00

(52) U.S. Cl. CPC G01M 13/005; F04B 51/00

(57) ABSTRACT

A life prediction method for shaft seal of pump includes following steps of: obtaining time domain vibration magnitudes of vibration signals of a pump; establishing a temporal vibration model according to time domain vibration magnitudes; inputting parameters of the pump under operation into temporal vibration model to convert into vibration spectrums by processing a Fourier transform, wherein the parameters include a rotation speed and a number of blades of the pump; extracting characteristic amplitudes of the pump according to vibration spectrums, combining characteristic amplitudes with each other and performing a dimensionality reduction process on characteristic amplitudes to generate characteristic combinations; establishing a life model according to characteristic combinations to store life model in a pump shaft seal life prediction system; and establishing at least one threshold value according to life model to compare at least one threshold value with characteristic amplitudes to determine life of shaft seal of pump.

### CROSS-REFERENCE TO RELATED APPLICATION

This application claims priority to China Application Serial Number 202411232408.1, filed Sep. 4, 2024, which is herein incorporated by reference in its entirety.

### BACKGROUND

### Field of Invention

The present disclosure relates to a pump shaft seal life prediction system and method. More particularly, the present disclosure relates to a pump shaft seal life prediction system and method which can establish a life model and accurately predict a life of a shaft seal.

### Description of Related Art

Nowadays, vibration accelerometers are configured to measure time domain vibration signals of a pump during operation and perform frequency domain conversion. Then, practitioners use relevant frequencies to find the characteristics and characteristic trends of the pump under normal and fault conditions.

However, this method of finding features is easily affected by the rotational speed, resulting in different distributions of vibration features, which will also lead to inaccurate predictions.

In addition, due to numerous failure factors of a pump, even experienced practitioners still cannot determine that specific parts in the pump (such as the shaft seal) are damaged based only on the vibration characteristics of the pump, and therefore cannot correctly estimate a shaft seal life of the pump.

For the foregoing reasons, there is a need for providing a suitable life prediction method for shaft seal of pump and a pump shaft seal life prediction system to solve the above problems encountered in related art approaches.

### SUMMARY

One aspect of the present disclosure provides a life prediction method for shaft seal of pump. The life prediction method for shaft seal of pump includes following steps of: obtaining a plurality of time domain vibration magnitudes of vibration signals of a pump by a pump shaft seal life prediction system; establishing a temporal vibration model according to the time domain vibration magnitudes by the pump shaft seal life prediction system; inputting a plurality of parameters of the pump under operation into the temporal vibration model to convert into a plurality of vibration spectrums by processing a Fourier transform by the pump shaft seal life prediction system, the parameters include a rotation speed and a number of blades of the pump; extracting a plurality of characteristic amplitudes of the vibration signals of the pump according to the vibration spectrums by the pump shaft seal life prediction system; combining the characteristic amplitudes with each other and performing a dimensionality reduction process on the characteristic amplitudes to generate a plurality of characteristic combinations by the pump shaft seal life prediction system; establishing a life model according to the characteristic combinations by the pump shaft seal life prediction system; and establishing at least one threshold value according to the life model to compare the at least one threshold value with the characteristic amplitudes to determine a life of a shaft seal of the pump by the pump shaft seal life prediction system.

Another aspect of the present disclosure provides a pump shaft seal life prediction system. The pump shaft seal life prediction system includes a pump, a vibration detection device, a storage and a processor. The vibration detection device is disposed on the pump, and is configured to obtain a plurality of time domain vibration magnitudes of vibration signals of the pump. The processor is electrically connected to the vibration detection device and the storage, and is configured to execute following steps of: establishing a temporal vibration model according to the time domain vibration magnitudes; inputting a plurality of parameters of the pump under operation into the temporal vibration model to convert into a plurality of vibration spectrums by processing a Fourier transform, wherein the parameters include a rotation speed and a number of blades of the pump; extracting a plurality of characteristic amplitudes of vibration signals of the pump according to the vibration spectrums; combining the characteristic amplitudes with each other and performing a dimensionality reduction process on the characteristic amplitudes to generate a plurality of characteristic combinations; establishing a life model according to the characteristic combinations to store the life model to the storage; and establishing at least one threshold value according to the life model to compare the at least one threshold value with the characteristic amplitudes to determine a life of a shaft seal of the pump.

In view of the aforementioned shortcomings and deficiencies of the prior art, the present disclosure provides a technology of a life prediction method for shaft seal of pump and a pump shaft seal life prediction system, which can determine an appropriate target characteristic combination and allow damage characteristics of the internal parts of a pump to be highlighted, and a degree of damage to a pump to be tested can be assessed. It can even predict parts life of a pump to be tested and assist a user in arranging a repair plan for a pump to be tested.

### BRIEF DESCRIPTION OF THE DRAWINGS

The present disclosure can be more fully understood by reading the following detailed description of the embodiment, with reference made to the accompanying drawings as follows:

FIG. 1 depicts a schematic diagram of a pump shaft seal life prediction system according to some embodiments of the present disclosure;

FIG. 2 depicts a flow chart of a life prediction method for shaft seal of pump according to some embodiments of the present disclosure;

FIG. 3 depicts a schematic diagram of an axial spectrum and a radial spectrum of partially damaged pump according to some embodiments of the present disclosure;

FIG. 4 depicts a schematic diagram of a multi-dimensional characteristic damage distribution map according to some embodiments of the present disclosure;

FIG. 5 depicts a schematic diagram of a multi-dimensional characteristic damage distribution map according to some embodiments of the present disclosure;

FIG. 6 depicts a schematic diagram of a multi-dimensional characteristic damage distribution map according to some embodiments of the present disclosure; and

FIG. 7 depicts a schematic diagram of a health index diagram of a pump according to some embodiments of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

The terminology used herein is for the purpose of describing particular example embodiments only and is not intended to be limiting of the present disclosure. As used herein, the singular forms “a,” “an” and “the” are intended to include the plural forms as well, unless the context clearly indicates otherwise.

Furthermore, it should be understood that the terms, “comprising”, “including”, “having”, “containing”, “involving” and the like, used herein are open-ended, that is, including but not limited to.

The terms used in this specification and claims, unless otherwise stated, generally have their ordinary meanings in the art, within the context of the disclosure, and in the specific context where each term is used. Certain terms that are used to describe the disclosure are discussed below, or elsewhere in the specification, to provide additional guidance to the practitioner skilled in the art regarding the description of the disclosure.

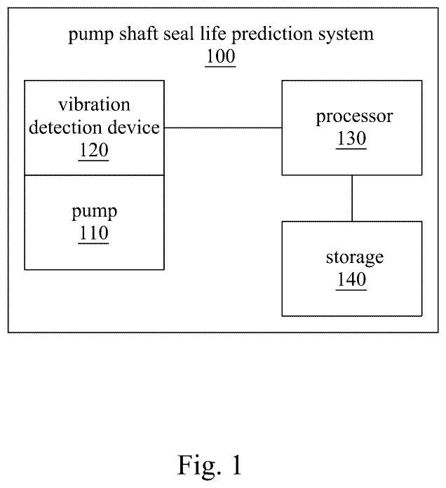

FIG. 1 depicts a schematic diagram of a pump shaft seal life prediction system 100 according to some embodiments of the present disclosure. The pump shaft seal life prediction system 100 includes a pump 110, a vibration detection device 120, a processor 130 and a storage 140. The vibration detection device 120 is disposed on the pump 110. The processor 130 is electrically coupled to the vibration detection device 120 and the storage 140.

In some embodiments, the vibration detection device 120 includes at least one of a set of a microphone, a three-axis sensor, a six-axis sensor, a nine-axis sensor, a gyroscope and micro electro mechanical systems (MEMS). In some embodiments, the vibration detection device 120 is configured to detect a state of the pump 110 under operation, and to receive information such as a relevant time domain vibration magnitude, frequency and a phase of each of vibration signals generated by various components in the pump 110 (generated by audio and vibration).

In some embodiments, the processor 130 includes but not limited to a single processor and an integration of many micro-processors, for example, a central processing unit (CPU), a digital signal processor (DSP) or a graphic processing unit (GPU) and other devices that can be used for computing.

In some embodiments, the storage 140 includes a flash memory, hard disk drive (HDD), a solid state drive (SSD), a dynamic random access memory (DRAM) or a static random access memory (SRAM).

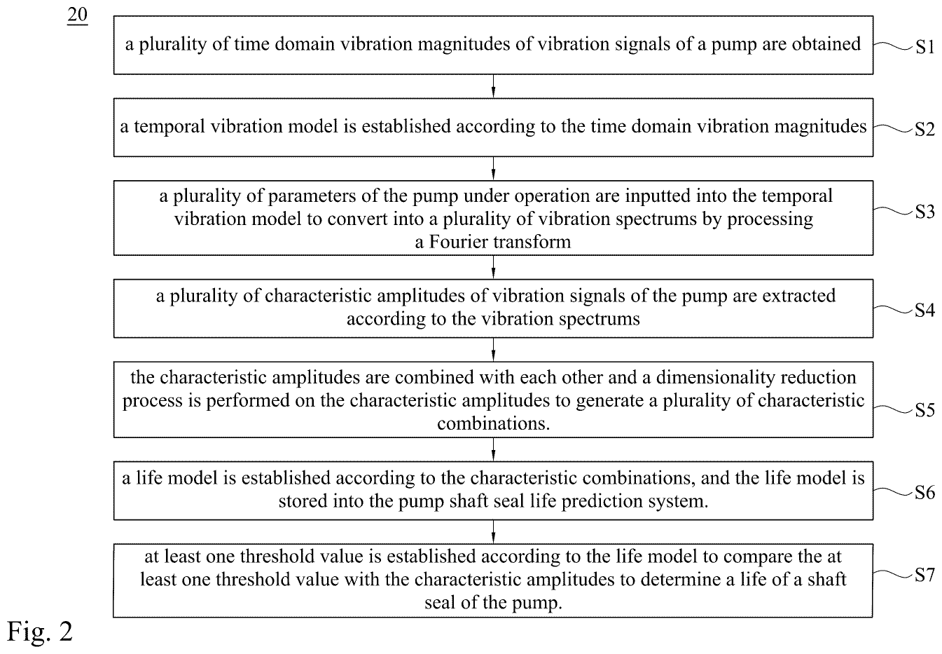

In order to facilitate the understanding operations of the pump shaft seal life prediction system 100, please refer to FIG. 1 to FIG. 2 together. FIG. 2 depicts a flow chart of a life prediction method for shaft seal of pump 20 according to some embodiments of the present disclosure. The life prediction method for shaft seal of pump 20 includes steps S1 to S7. In some embodiments, the life prediction method for shaft seal of pump 20 can be executed by the pump shaft seal life prediction system 100.

In step S1, the vibration detection device 120 of the pump shaft seal life prediction system 100 is configured to obtain a plurality of vibration signals of the pump 110. The vibration detection device 120 is configured to obtain a plurality of time domain vibration magnitudes, frequencies and phases of the vibration signals of the pump 110.

In step S2, the processor 130 of the pump shaft seal life prediction system 100 is configured to establish a temporal vibration model (or called time domain vibration model) according to the time domain vibration magnitudes of the vibration signals.

In step S3, the processor 130 of the pump shaft seal life prediction system 100 is configured to input a plurality of parameters of the pump 110 under operation into the temporal vibration model (or called time domain vibration model) to convert the parameters into a plurality of vibration spectrums by processing a Fourier transform (or called (creating) Fourier frequency domain models). The parameters of the pump 110 under operation include a rotational speed and a number of blades of the pump 110. In some embodiments, the processor 130 is configured to convert the vibration signals in time domain into the vibration signals in frequency domain.

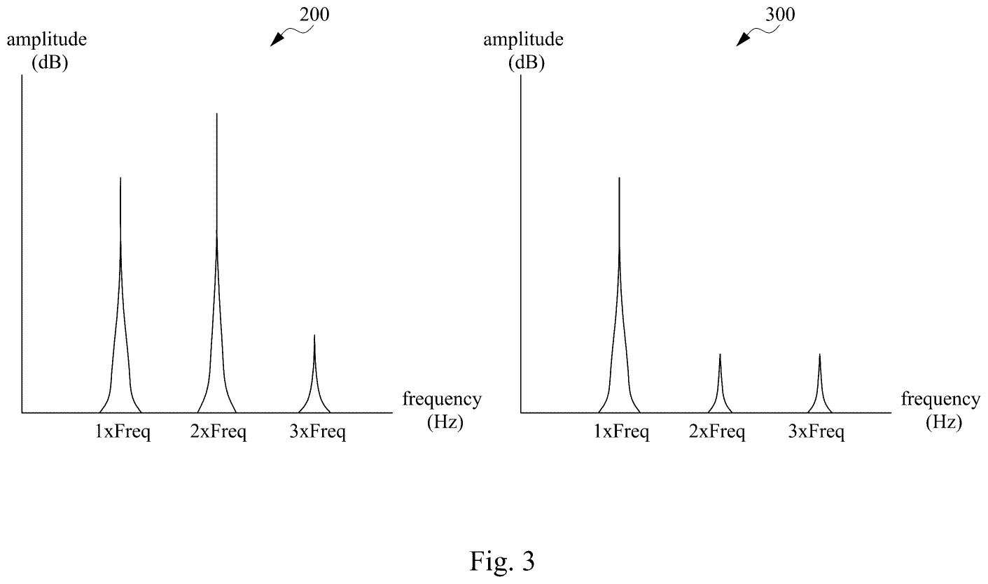

In step S4, the processor 130 of the pump shaft seal life prediction system 100 is configured to extract a plurality of characteristic amplitudes of the pump 110 according to the vibration spectrums by processing a Fourier transform (or called Fourier frequency domain models). In order to facilitate the understanding operations of the processor 130 to extract a plurality of characteristic amplitudes of the pump 110 from the Fourier frequency domain models, please refer to FIG. 3. FIG. 3 depicts a schematic diagram of a radial spectrum 200 and an axial spectrum 300 of partially damaged pump 110 according to some embodiments of the present disclosure.

In some embodiments, the processor 130 of the pump shaft seal life prediction system 100 is configured to obtain the radial spectrum 200 and the axial spectrum 300 according to the vibration spectrums by processing a Fourier transform (or called Fourier frequency domain models). The axial spectrum 300 is configured to indicate a vibration component of the pump 110 in a vibration direction. The radial spectrum 200 is configured to indicate a vibration component of the pump 110 in a radial vibration direction. After the pump 110 has been operated for a period of time, impurities in the water may wear or adhere to the parts in the pump 110, or the parts of the pump 110 may become deformed, causing the center of gravity of the parts to become unbalanced, and then manifested in the frequency changes of the radial spectrum 200 and the axial spectrum 300.

Please refer to FIG. 2 and FIG. 3, the processor 130 of the pump shaft seal life prediction system 100 is configured to obtain a plurality of fundamental rotational frequencies (e.g.: a fundamental rotational frequency 1×Freq, two times fundamental rotational frequency 2×Freq and three times fundamental rotational frequency 3×Freq in the radial spectrum 200 and the axial spectrum 300 of FIG. 3, wherein the 2×Freq and 3×Freq are harmonics of the fundamental rotation frequency 1×Freq) corresponding to rotational speeds of the pump 110 from one of the radial spectrum 200 and the axial spectrum 300. The processor 130 is configured to extract a plurality of fundamental rotational frequencies corresponding to target components (e.g.: shaft seal) from the fundamental rotational frequencies according to a plurality of preset multiplication frequency thresholds of the target components to be tested (e.g.: shaft seal) of the pump 110 as the characteristic amplitudes of the target components. The characteristic amplitudes correspond to a vibration signal of the first fundamental rotational frequencies.

For example, when the shaft seal of the pump 110 is damaged, a fundamental rotational frequency 1×Freq of the axial spectrum 300 of the pump 110 is higher than a preset multiplication frequency threshold, the two times fundamental rotational frequency 2×Freq and the three times fundamental rotational frequency 3×Freq are lower than the preset multiplication frequency threshold, so as to extract from the fundamental rotational frequency 1×Freq to the three times fundamental rotational frequency 3×Freq as the characteristic amplitudes of shaft seal of the pump 110. It should be noted that, the axial spectrum and the radial spectrum when each component in the pump 110 is damaged are different, but the corresponding characteristic amplitudes can be extracted in a similar way.

Nowadays, vibration accelerometers are configured to measure vibration time domain signals of a pump during operation and perform frequency domain conversion. Then, practitioners use relevant frequencies to find the characteristics and characteristic trends of the pump under normal and fault conditions. However, this method of finding features is easily affected by the rotational speed, resulting in different distributions of vibration features, which will also lead to inaccurate predictions. In addition, due to numerous failure factors of a pump, even experienced practitioners still cannot determine that specific parts in the pump (such as the shaft seal) are damaged based only on the vibration characteristics of the pump, and therefore cannot correctly estimate a shaft seal life of the pump. The present disclosure will describe implementation methods to solve the aforementioned problems in following paragraph.

In step S5, the processor 130 of the pump shaft seal life prediction system 100 is configured to combine the characteristic amplitudes with each other and perform a dimensionality reduction process on the characteristic amplitudes to generate a plurality of characteristic combinations.

In some embodiments, the processor 130 of the pump shaft seal life prediction system 100 is configured to calculate a plurality of blade multiplication frequencies as the characteristic amplitudes according to the fundamental rotational frequencies and the number of blades of the pump 110.

For example, the processor 130 is configured to calculate the blade multiplication frequencies (e.g.: one time blade multiplication frequency 1×BPF, two times blade multiplication frequency 2×BPF, three times blade multiplication frequency 3×BPF, . . . to M times blade multiplication frequency M×BPF) according to the fundamental rotational frequencies (e.g.: the fundamental rotational frequency 1×Freq, the two times fundamental rotational frequency 2×Freq, the three times fundamental rotational frequency 3×Freq, . . . to N times fundamental rotational frequency N×Freq) of an operating frequency of 60 Hz and the number of blades is 5. Where M and N are positive integers.

Then, the processor 130 of the pump shaft seal life prediction system 100 is configured to match the at least one of fundamental rotational frequencies with the at least one of blade multiplication frequencies under different operating frequencies (e.g.: the operating frequencies are 30 Hz, 40 Hz and 60 Hz respectively) to generate a plurality of characteristic combinations respectively. Furthermore, the processor 130 is configured to establish a multi-dimensional characteristic damage distribution map corresponding to each of the characteristic combinations according to the characteristic combinations. Finally, the processor 130 is configured to determine a target characteristic combination (i.e.: the best characteristic combination) according to the multi-dimensional characteristic damage distribution maps. For example, please refer to Table 1 below for the characteristic combinations.

TABLE 1

| | | X-axis of | Y-axis of | Z-axis of |
|---|---|---|---|---|
| | | multi-dimensional | multi-dimensional | multi-dimensional |
| Characteristic | operating | characteristic | characteristic | characteristic |
| combination | frequency | damage | damage | damage |
| table | of pump | distribution map | distribution map | distribution map |
| Characteristic | 30 Hz | 1 × Freq | 1 × BPF | 3 × BPF |
| combination 1 | | | | |
| Characteristic | 30 Hz | 1 × Freq | 2 × Freq | 3 × BPF |
| combination 2 | | | | |
| Characteristic | 30 Hz | 4 × Freq | 3 × BPF | 6 × BPF |
| combination 3 | | | | |
| Characteristic | 40 Hz | 1 × Freq | 1 × BPF | 3 × BPF |
| combination 4 | | | | |
| Characteristic | 40 Hz | 1 × Freq | 2 × Freq | 3 × BPF |
| combination 5 | | | | |
| Characteristic | 40 Hz | 5 × Freq | 4 × BPF | 8 × BPF |
| combination 6 | | | | |
| Characteristic | 60 Hz | 1 × Freq | 1 × BPF | 3 × BPF |
| combination 7 | | | | |
| Characteristic | 60 Hz | 1 × Freq | 2 × Freq | 3 × BPF |
| combination 8 | | | | |
| Characteristic | 60 Hz | 3 × Freq | 2 × BPF | 3 × BPF |
| combination 9 | | | | |
| . . . | . . . | . . . | . . . | . . . |
| . . . | . . . | . . . | . . . | . . . |

It should be noted that a number of parameters and combination contents of the characteristic combinations in Table 1 are not limited to the embodiments of the table.

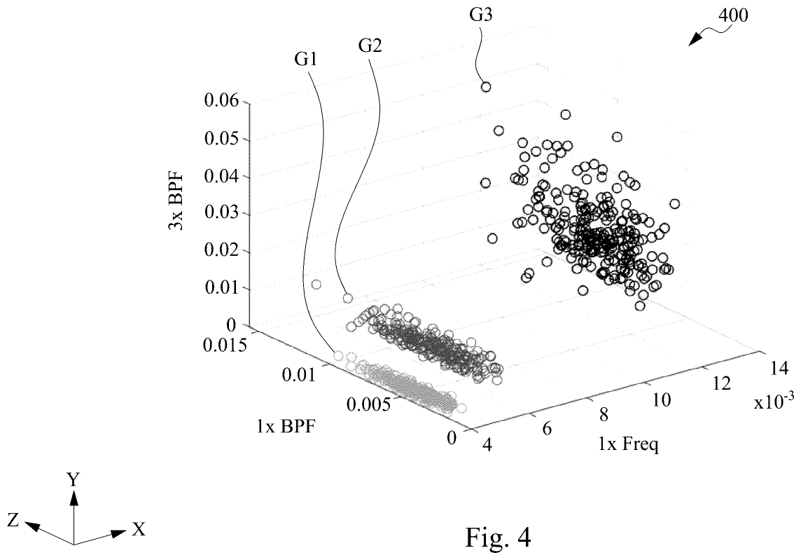

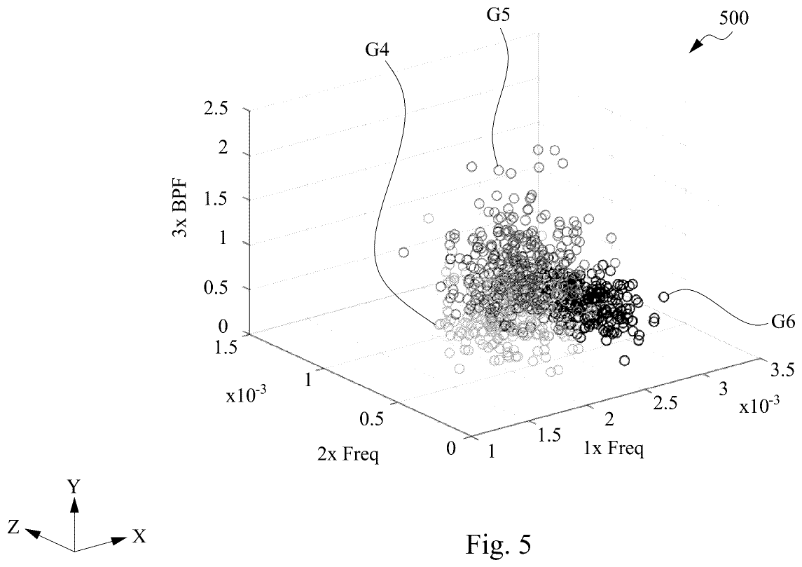

In order to facilitate the understanding details steps of life prediction method for shaft seal of pump 20, please refer FIG. 4 to FIG. 5 again. FIG. 4 depicts a schematic diagram of a multi-dimensional characteristic damage distribution map 400 according to some embodiments of the present disclosure. FIG. 5 depicts a schematic diagram of a multi-dimensional characteristic damage distribution map 500 according to some embodiments of the present disclosure. Please refer to FIG. 2, FIG. 4 and FIG. 5, the multi-dimensional characteristic damage distribution map 400 corresponds to the characteristic combination 7 of the pump 110 at the operating frequency of 60 Hz in Table 1 (e.g.: a fundamental rotational frequency 1×Freq, one time blade multiplication frequency 1×BPF and the three times blade multiplication frequency 3×BPF). The multi-dimensional characteristic damage distribution map 500 corresponds to the characteristic combination 2 of the pump 110 at the operating frequency of 30 Hz in Table 1 (e.g.: a fundamental rotational frequency 1×Freq, two times fundamental rotational frequency 2×Freq and three times blade multiplication frequency 3×BPF).

Then, the processor 130 is configured to execute following detail steps for each of the multi-dimensional characteristic damage distribution maps corresponding to all characteristic combinations in the corresponding candidate characteristic combination list (e.g.: Table 1).

In some embodiments, the processor 130 is configured to calculate an overlap ratio of each of a plurality of damage distribution groups of each of the multi-dimensional characteristic damage distribution maps corresponding to each characteristic combination in the candidate characteristic combination list (e.g.: Table 1). The overlap ratio is configured to indicate an overlapping situation of the damage distribution groups. Then, the processor 130 is configured to determine a target multi-dimensional characteristic damage distribution map according to the overlap ratios of the multi-dimensional characteristic damage distribution maps corresponding to all characteristic combinations (i.e.: the multi-dimensional characteristic damage distribution map with the lowest overlap ratio). The target multi-dimensional characteristic damage distribution map corresponds to the target characteristic combination.

For example, please refer to FIG. 4, the processor 130 is configured to calculate overlap ratios between a damage distribution group G1 (or called cluster), a damage distribution group G2 (or called cluster) and a damage distribution group G3 (or called cluster) in the multi-dimensional characteristic damage distribution map 400 corresponding to the characteristic combination 7 (e.g.: a fundamental rotational frequency 1×Freq, one time blade multiplication frequency 1×BPF and three times blade multiplication frequency 3×BPF) of the pump 110 at the operating frequency of 60 Hz. Please refer to FIG. 5 again, the processor 130 is configured to calculate overlap ratios between a damage distribution group G4 (or called cluster), a damage distribution group G5 (or called cluster) and a damage distribution group G6 (or called cluster) in the multi-dimensional characteristic damage distribution map 500 corresponding to the characteristic combination 2 (e.g.: a fundamental rotational frequency 1×Freq, two times fundamental rotational frequency 2×Freq and three times blade multiplication frequency 3×BPF) of the pump 110 at the operating frequency of 30 Hz. In other words, the processor 130 is configured to calculate the multi-dimensional characteristic damage distribution maps of all characteristic combinations (e.g.: characteristic combinations 1-9) in the candidate characteristic combination list (e.g.: Table 1).

Then, the processor 130 is configured to select the target multi-dimensional characteristic damage distribution map (i.e., the multi-dimensional characteristic damage distribution map with the lowest overlap ratios) and the target characteristic combination from the multi-dimensional characteristic damage distribution maps of all characteristic combinations to establish a life model. For example, the multi-dimensional characteristic damage distribution map 400 in FIG. 4 and the corresponding characteristic combination 7 in Table 1.

In some embodiments, the candidate characteristic combination list (e.g.: Table 1) is generated by following steps. Please refer to FIG. 4, the processor 130 is configured to calculate a plurality of group centers among the damage distribution group G1, the damage distribution group G2 and the damage distribution group G3 in the multi-dimensional characteristic damage distribution map 400. The processor 130 is configured to determine whether a Euclidean distance corresponding to each of the group centers of multi-dimensional characteristic damage distribution map (e.g.: a Euclidean distance between the damage distribution group G1 and the damage distribution group G2, a Euclidean distance between the damage distribution group G1 and the damage distribution group G3 and a Euclidean distance between the damage distribution group G2 and the damage distribution group G3) is greater than a plurality of distance thresholds. The processor 130 is configured to add the multi-dimensional characteristic damage distribution map (e.g.: multi-dimensional characteristic damage distribution map 400) to the candidate characteristic combination list (e.g.: Table 1) in response to the Euclidean distance of each of the group centers of the multi-dimensional characteristic damage distribution map being greater than distance thresholds. In other words, the processor 130 is further configured to determine whether the Euclidean distance between the plurality of group centers of the plurality of multi-dimensional characteristic damage distribution maps is greater than a plurality of distance thresholds, so as to narrow the range of data that needs to be calculated. Therefore, a technology of the candidate characteristic combination list allows the present disclosure to obtain the target multi-dimensional characteristic damage distribution map more quickly.

In some embodiments, if there are a plurality of multi-dimensional characteristic damage distribution maps that meet the aforementioned conditions, the processor 130 is further configured to select the target multi-dimensional characteristic damage distribution map from the multi-dimensional characteristic damage distribution maps (i.e. a multi-dimensional characteristic damage distribution map with relatively low overlap ratios and relatively large Euclidean distances between a plurality of group centers or clusters) and corresponding target characteristic combination.

In some embodiments, if none of the multi-dimensional characteristic damage distribution maps meets the aforementioned conditions, the processor 130 is further configured to select the target multi-dimensional characteristic damage distribution map from the multi-dimensional characteristic damage distribution maps (i.e. a multi-dimensional characteristic damage distribution map with relatively low overlap ratios and relatively large Euclidean distances between a plurality of group centers or clusters) and corresponding target characteristic combination.

It should be noted that in the present disclosure, the target multi-dimensional characteristic damage distribution map and the target characteristic combination are selected to establish a life model by comparing and judging discrete conditions of a plurality of multi-dimensional characteristic damage distribution maps corresponding to multiple characteristic combinations (e.g. group distance between group centers is greater than the preset distance threshold and overlapping states of groups).

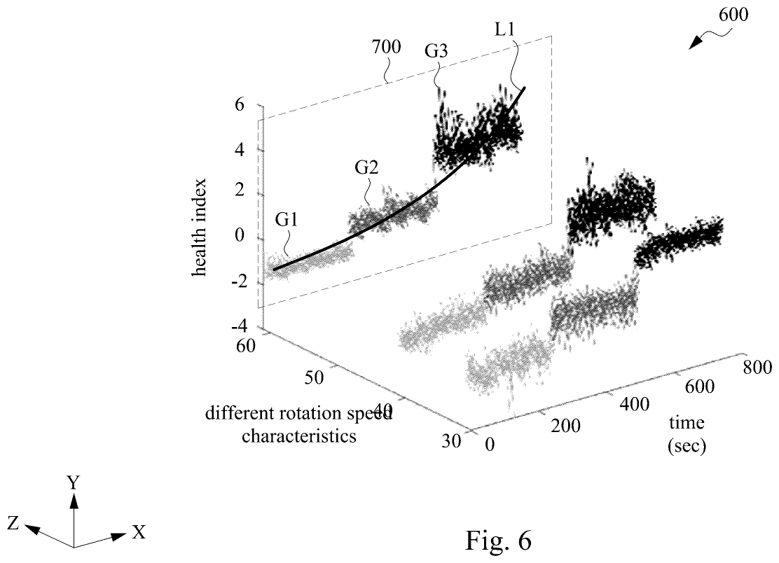

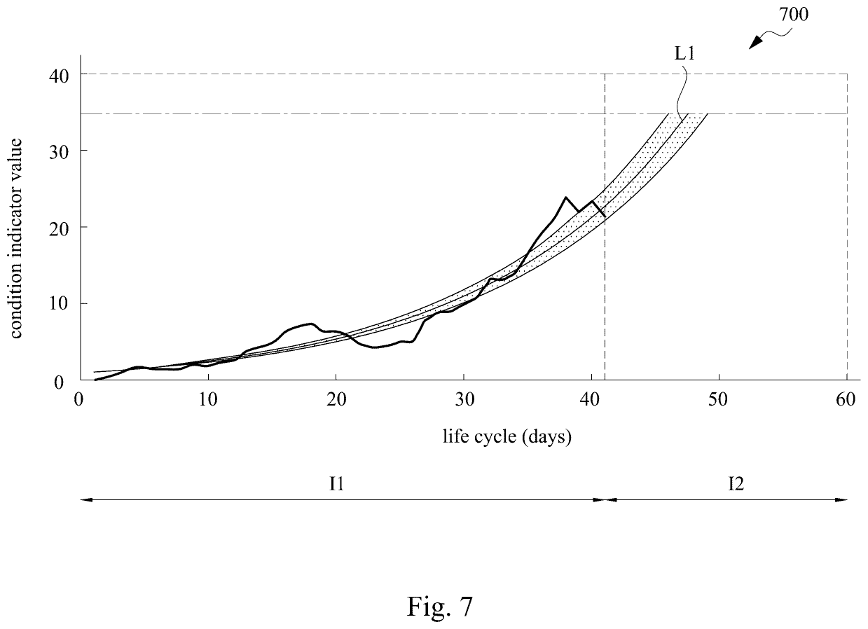

In order to facilitate the understanding operations of dimensionality reduction processing of the multi-dimensional characteristic damage distribution of the present disclosure, please refer to FIG. 1, FIG. 2, FIG. 4, FIG. 6 and FIG. 7. FIG. 6 depicts a schematic diagram of a multi-dimensional characteristic damage distribution map 600 according to some embodiments of the present disclosure. FIG. 7 depicts a schematic diagram of a health index diagram 700 of the pump 110 according to some embodiments of the present disclosure. Following the aforementioned content, the processor 130 of the pump shaft seal life prediction system 100 is configured to select the best multi-dimensional characteristic damage distribution map (the multi-dimensional characteristic damage distribution map 400 shown in FIG. 4, which operates at 60 Hz), and convert it into the multi-dimensional characteristic damage distribution map 600 shown in FIG. 6. The processor 130 of the pump shaft seal life prediction system 100 is configured to perform dimensionality reduction processing according to the multi-dimensional characteristic damage distribution map 400 with an operating frequency of 60 Hz, a situation before and after the dimensionality reduction process is as shown in the health index diagram 700 shown in FIG. 6 and FIG. 7, and a trend curve L1 is obtained. In some embodiments, dimensionality reduction processing can be implemented as one of principal component analysis (PCA) processing, factor analysis processing, cluster analysis processing, multidimensional scoring processing and decision trees processing, but it is not limited to the scope of the methods mentioned in this case. In some embodiments, the processor 130 of the pump shaft seal life prediction system 100 is further configured to standardize the dimensionality reduction health index diagram 700.

In step S6, the processor 130 of the pump shaft seal life prediction system 100 is configured to establish a life model according to the characteristic combinations, and store the life model into the pump shaft seal life prediction system 100. Following the content of the aforementioned step S5, the processor 130 is configured to establish the life model according to the health index diagram 700 in FIG. 7, and store the life model into the storage 140 of the pump shaft seal life prediction system 100.

In step S7, the processor 130 of the pump shaft seal life prediction system 100 is configured to establish at least one threshold value according to the life model to compare the at least one threshold value with the characteristic amplitudes to determine a life of a shaft seal of the pump 110.

In some embodiments, the threshold value can be set to threshold values in different ranges such as 0%-30%, 30%-50% and 50%-100% to distinguish shaft seals with different degrees of damage. A numerical range of the threshold value can be adjusted according to actual needs and is not limited to the embodiment of the present disclosure.

In some embodiments, please refer to FIG. 1, FIG. 2 and FIG. 7, the storage 140 is configured to store a plurality of historical life models. The historical life models are generated according to a plurality of historical Fourier frequency domain models. An establishment method of individual historical life models is similar to an establishment method of the aforementioned life models, and repetitious details are omitted herein. In some embodiments, each of the historical life models corresponds to a target operating frequency and a target characteristic combination. The processor 130 is configured to select a vibration signal corresponding to the target operating frequency and the target characteristic combination of the historical life model from the characteristic amplitudes corresponding to a plurality of vibration signals of the pump 110. An operating frequency of the first vibration signal is selected from one of the target operating frequencies, and the target characteristic combination includes at least one rotational frequency and at least one blade multiplication frequency. Each of the vibration signals corresponds to one of the rotational frequencies and one of the blade multiplication frequencies.

For example, the storage 140 is configured to store characteristic combinations (e.g. various characteristic combinations in the aforementioned Table 1) under different operating frequencies (e.g. the operating frequencies are 20 Hz, 30 Hz and 50 Hz respectively). It should be noted that, the above operating frequency is only one parameter of various characteristic combinations. The method of the present disclosure can use characteristic combinations with a plurality of parameters, which can improve calculation flexibility and prediction accuracy.

The processor 130 of the pump shaft seal life prediction system 100 is configured to select a historical life model corresponding the operating frequency (e.g. 30 Hz) from the historical life models in the storage 140 according to the operating frequency (e.g. 30 Hz) of the pump 110.

In some embodiments, the pump shaft seal life prediction system 100 is also configured to integrate a plurality of historical life models corresponding to different frequency ranges (or called the operating frequency) into a single model for model training and usage. The integrated single model can perform life prediction for data in different frequency ranges (or called the operating frequency).

Furthermore, the processor 130 of the pump shaft seal life prediction system 100 is configured to select a historical life model of the characteristic combination (e.g. a fundamental rotational frequency 1×Freq, one time blade multiplication frequency 1×BPF and three times blade multiplication frequency 3×BPF) corresponding to the operating frequency (e.g. 30 Hz) according to the characteristic combination (e.g. a fundamental rotational frequency 1×Freq, one time blade multiplication frequency 1×BPF and three times blade multiplication frequency 3×BPF) of the operating frequency (e.g. 30 Hz) of the pump 110 from the historical life models of the storage 140.

In some embodiments, the processor 130 is configured to input the characteristic amplitudes of the pump 110 to the corresponding historical life model to assess a current degree of damage to the pump 110. The processor 130 is configured to update the at least one threshold value according to the current degree of damage to the pump 110. In other words, the processor 130 is configured to adjust the threshold value according to the pump 110 in different damage situations or situations of the pump 110 at different time points. The processor 130 is configured to collect and analyze the characteristic amplitudes of the pump 110 in the stage 11 shown in FIG. 7 in the above manner, and predicts the trend curve L1 of a subsequent operation of the pump 110 (i.e., stage 12).

Based on the aforementioned embodiments, the present disclosure provides a design of a life prediction method for shaft seal of a pump and a pump shaft seal life prediction system, which allows damage characteristics of the internal parts of a pump to be highlighted, and a degree of damage to a pump to be tested can be assessed. It can even predict parts life of a pump to be tested and assist a user in arranging a repair plan for a pump to be tested.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the present disclosure. In view of the foregoing, it is intended that the present disclosure cover modifications and variations of the present disclosure provided they fall within the scope of the following claims.

What is claimed is:

1. A life prediction method for shaft seal of pump, comprising steps of:
obtaining a plurality of time domain vibration magnitudes of vibration signals of a pump;
establishing a temporal vibration model according to the time domain vibration magnitudes;
inputting a plurality of parameters of the pump under operation into the temporal vibration model to convert the parameters into a plurality of vibration spectrums by processing a Fourier transform, wherein the parameters comprise a rotation speed and a number of blades of the pump;
extracting a plurality of characteristic amplitudes of the vibration signals of the pump according to the vibration spectrums;
combining the characteristic amplitudes with each other and performing a dimensionality reduction process on the characteristic amplitudes to generate a plurality of characteristic combinations;
establishing a life model according to the characteristic combinations; and
establishing at least one threshold value according to the life model to compare the at least one threshold value with the characteristic amplitudes to determine a life of a shaft seal of the pump.

2. The life prediction method for shaft seal of pump of claim 1, wherein the step of extracting the characteristic amplitudes of the vibration signals of the pump according to the vibration spectrums comprises steps of:
obtaining an axial spectrum and a radial spectrum of the pump according to the vibration spectrums;
obtaining a plurality of fundamental rotational frequencies corresponding to each of the rotational speeds from one of the radial spectrum and the axial spectrum according to an operating frequency of the pump; and
extracting a plurality of first fundamental rotational frequencies from the fundamental rotational frequencies as the characteristic amplitudes according to a plurality of preset multiplication frequency thresholds of a target component of the pump, wherein the characteristic amplitudes correspond to a vibration signal of the first fundamental rotational frequencies.

3. The life prediction method for shaft seal of pump of claim 2, further comprising steps of:
calculating a plurality of blade multiplication frequencies as the characteristic amplitudes according to the first fundamental rotational frequencies and the number of blades;
pairing at least one of the first fundamental rotational frequencies with at least one of the blade multiplication frequencies to generate the characteristic combinations respectively;
establishing a plurality of multi-dimensional characteristic damage distribution maps corresponding to each of related characteristic combinations; and
determining a target characteristic combination according to the multi-dimensional characteristic damage distribution maps.

4. The life prediction method for shaft seal of pump of claim 3, wherein the step of determining the target characteristic combination further comprises steps of:
performing following steps for each of the multi-dimensional characteristic damage distribution maps corresponding to a candidate characteristic combination list:
calculating an overlap ratio of each of a plurality of damage distribution groups corresponding to a first multi-dimensional characteristic damage distribution map, wherein the overlap ratio is configured to indicate an overlapping situation of the damage distribution groups; and
determining a target multi-dimensional characteristic damage distribution map according to the overlap ratios corresponding to the multi-dimensional characteristic damage distribution maps, wherein the target multi-dimensional characteristic damage distribution map corresponds to the target characteristic combination.

5. The life prediction method for shaft seal of pump of claim 4, wherein the candidate characteristic combination list is generated by following steps of:
calculating a plurality of group centers of the multi-dimensional characteristic damage distribution maps;
determining whether a Euclidean distance corresponding to each of the group centers of a second multi-dimensional characteristic damage distribution map is greater than a plurality of distance thresholds; and
adding the second multi-dimensional characteristic damage distribution map to the candidate characteristic combination list in response to the Euclidean distance of each of the group centers of the second multi-dimensional characteristic damage distribution map being greater than the distance thresholds.

6. The life prediction method for shaft seal of pump of claim 4, further comprising a step of:
establishing the life model according to the target multi-dimensional characteristic damage distribution map and the target characteristic combination.

7. The life prediction method for shaft seal of pump of claim 1, further comprising a step of:
storing a plurality of historical life models, wherein the historical life models are generated according to a plurality of historical vibration spectrums, and each of the historical life models corresponding to a target operating frequency and a target characteristic combination.

8. The life prediction method for shaft seal of pump of claim 7, wherein the step of comparing the at least one threshold value with the characteristic amplitudes to determine the life of the shaft seal of the pump comprises steps of:
selecting a first historical life model corresponding to the historical life models according to an operating frequency of the pump;
inputting the characteristic amplitudes to the first historical life model to assess a current degree of damage to the pump; and
updating the at least one threshold value according to the current degree of damage to the pump.

9. The life prediction method for shaft seal of pump of claim 8, wherein the step of comparing the at least one threshold value with the characteristic amplitudes to determine the life of the shaft seal of the pump further comprises a step of:
selecting a first vibration signal corresponding to the target operating frequency and the target characteristic combination of the first historical life model from the characteristic amplitudes corresponding to the vibration signals of the pump,
wherein an operating frequency of the first vibration signal is selected from one of the target operating frequencies, and the target characteristic combination comprises at least one first rotational frequency and at least one first blade multiplication frequency.

10. The life prediction method for shaft seal of pump of claim 9, wherein each of the vibration signals corresponds to one of the rotational frequencies and one of the blade multiplication frequencies.

11. A pump shaft seal life prediction system, comprising:
a pump;
a vibration detection device, disposed on the pump, and configured to obtain a plurality of time domain vibration magnitudes of vibration signals of the pump;
a storage; and
a processor, electrically connected to the vibration detection device and the storage, and configured to execute following steps of:
establishing a temporal vibration model according to the time domain vibration magnitudes;
inputting a plurality of parameters of the pump under operation into the temporal vibration model to convert the parameters into a plurality of vibration spectrums by processing a Fourier transform, wherein the parameters comprise a rotation speed and a number of blades of the pump;
extracting a plurality of characteristic amplitudes of the vibration signals of the pump according to the vibration spectrums;
combining the characteristic amplitudes with each other and performing a dimensionality reduction process on the characteristic amplitudes to generate a plurality of characteristic combinations;
establishing a life model according to the characteristic combinations to store the life model to the storage; and
establishing at least one threshold value according to the life model to compare the at least one threshold value with the characteristic amplitudes to determine a life of a shaft seal of the pump.

12. The pump shaft seal life prediction system of claim 11, wherein the storage is configured to store a plurality of historical life models, wherein the historical life models are generated according to a plurality of historical vibration spectrums, and each of the historical life models corresponds to a target operating frequency and a target characteristic combination.

13. The pump shaft seal life prediction system of claim 12, wherein the processor is further configured to execute following steps of:
selecting a first historical life model corresponding to the historical life models according to an operating frequency of the pump;
inputting the characteristic amplitudes to the first historical life model to assess a current degree of damage to the pump; and
updating the at least one threshold value according to the current degree of damage to the pump.

14. The pump shaft seal life prediction system of claim 13, wherein the processor is further configured to execute following steps of:
selecting a first vibration signal corresponding to the target operating frequency and the target characteristic combination of the first historical life model from the characteristic amplitudes corresponding to a plurality of vibration signals of the pump,
wherein an operating frequency of the first vibration signal is selected from one of the target operating frequency, and the target characteristic combination comprises at least one first rotational frequency and at least one first blade frequency.

15. The pump shaft seal life prediction system of claim 14, wherein each of the vibration signals corresponds to one of the rotational frequencies and one of blade multiplication frequencies.
